(19) United States
(12) Patent Application Publication
(10) Pub. No.: US 2026/0340767 A1
(43) Pub. Date: Oct. 29, 2026

(54) METHODS AND SYSTEMS FOR PROVIDING AN ENHANCED STREAM OF DIGITAL CONTENT

(71) Applicant: Adeia Guides Inc., San Jose, CA (US)

(72) Inventor: Tao Chen, Palo Alto, CA (US)

(21) Appl. No.: 19/188,611

(22) Filed: Apr. 24, 2025

(51) Int. Cl. G06T 3/4053; G06T 5/50; G06V 10/25

(52) U.S. Cl. CPC G06T 3/4053; G06T 5/50; G06V 10/25

(57) ABSTRACT

Systems and methods are described for providing an enhanced stream of digital content between first and second devices. Video data is accessed by a first device for encoding, and the accessed video data is encoded at a resolution to generate a first plurality of encoded frames, comprising a number of pixels. A region of interest (ROI) of the video data is identified, wherein the ROI has the number of pixels. ROI data is encoded based on the identified ROI, at the resolution to generate a second plurality of encoded frames, comprising the number of pixels. The first and second plurality of encoded frames are transmitted to a second device for decoding, the second device configured to: decode the first and second plurality of encoded frames using a single decoder; and generate an output video based on the first and second plurality of decoded frames.

### BACKGROUND

The present disclosure relates to methods and systems for providing a stream of digital content with information for enhancing a region of interest.

### SUMMARY

Video encoding is a fundamental process in computerized handling of digital media that enables the efficient storage in transitory and/or non-transitory memory devices and efficient transmission of video content via computer networks. In some approaches, video compression techniques in addition to intra-frame encoding also perform inter-frame encoding by exploiting spatial and/or temporal redundancies within a sequence of video frames to reduce the amount of data required to create a video stream. This may be achieved using various encoding techniques such as transform coding, motion estimation, and entropy coding, which collectively allow for significant data reduction while preserving perceptual video quality.

Video compression, however, inherently involves a trade-off between bitrate and quality. Higher compression levels result in bitstreams requiring lower bitrates, reducing storage requirements and bandwidth consumption, but at the cost of introducing compression artefacts such as blurring, blocking, and loss of fine detail. Conversely, maintaining high visual quality with a lower compression level results in bitstreams necessitating higher bitrates, which increases data transmission requirements and can lead to buffering or playback interruptions, particularly in bandwidth-constrained environments, such as mobile networks.

In the context of video streaming, adaptive bitrate (ABR) streaming techniques may be used to dynamically adjust the quality of streamed video based on network conditions. ABR algorithms can adaptively select or encode streams based on a set of bitrate-quality levels, based on available bandwidth, device capabilities, and buffering considerations. In some approaches, a system or software may mandate a switch in stream quality following a specific trigger. For example, in a video conferencing application, upon the detection of audio (such as audio comprising speech) at a user device participating in a video conference, the application may initiate the switching of a stream quality of video streamed from the user device to an enhanced stream quality, for example a higher resolution. Such an enhancement may be the result of a selection of higher bitrate encoding parameters used to encode the video stream from the user device, or by the server that offers ABR streaming to the conference participants. While such ABR approaches help to mitigate playback disruptions and improve the user experience, adaptively changing bitrate versions during a stream in this manner invariably involves using different encoder and decoder levels or settings, each associated with a corresponding resolution, necessitating a switching between multiple encoder and decoder instances during a stream, thereby requiring a greater resource usage and increased pipeline complexity.

Various visual enhancement processes, such as upscaling and post-processing techniques, may also be used to improve the perceived quality of compressed video, and may in some cases act to improve the quality of a stream subjected to higher compression levels. These methods may use interpolation, deep learning-based super-resolution, and other enhancement algorithms to generate higher-resolution frames from lower-bitrate inputs. Such enhancement techniques are, however, inherently constrained by the quality of the underlying compressed video. If the lower-bitrate stream contains significant compression artefacts or lacks fine details, enhancement and upscaling can only provide a limited improvement in visual quality metrics, often leading to unnatural textures or amplified artefacts. These processes, moreover, can introduce additional computational overhead, particularly when applied to the entire frame of a video stream, which may not be suitable for all streaming devices or real-time playback scenarios.

Accordingly, there remains a need for improved techniques that provide more flexible and intelligent video encoding and streaming strategies which require fewer instances of encoder and decoder level switching. Such techniques could enable more efficient use of network resources while maintaining or improving perceived video quality beyond the constraints of such ABR-based approaches.

To help address these problems, systems and methods are described herein for encoding and decoding a visually enhanced video stream.

The present disclosure may be performed by any suitable combination of encoder and decoder hardware, which may for example be any suitable one or more hardware components of a distributed system. The present disclosure may be performed as encoding and decoding steps within any suitable encoding or decoding pipeline, which may be comprised at least in-part within the functionality of an operating system of a computing device, at least in-part within the functionality of one or more software applications executed on a computing device, or any combination thereof.

In some embodiments, a first device (e.g., a device that is encoding video) may access video data (e.g., video captured by a camera for transmission into a video conference) for encoding. The video data may be any suitable video data comprising, or characterizing, one or more video frames. In some examples the video data may comprise audio data corresponding to, or accompanying, the one or more video frames. The accessing of the video data may comprise any suitable receiving or retrieving of the video data by the first device, for example by way of one or more image capture devices or transitory or non-transitory storage device. The accessing of the video data may in some examples comprise any suitable capturing of the video data by way of one or more image capture devices (e.g., cameras).

The first device, using encoding hardware and/or software thereof, may encode the video data at a particular resolution to generate a first plurality of encoded frames, wherein each frame of the first plurality of frames comprises a particular number of pixels (e.g., 230,400 pixels arranged in 640×360 rectangle). The particular resolution may be any suitable resolution corresponding to an encoder level, which may in some examples be determined based on any suitable factors such as an available network bandwidth or a predefined streaming profile. The encoder level may, for example, be selected from one or more predefined encoding profiles, may be dynamically adjusted based on real-time network conditions using adaptive bitrate streaming (ABR) techniques, or may be determined based on one or more encoder settings, such as user-specified encoder settings.

The first device may identify a region of interest of the video data (e.g., original raw video whose resolution may be higher than that represented in the first plurality of encoded frames), wherein the region of interest comprises the particular number of pixels (e.g., 230,400 pixels arranged in 640×360 rectangle). It will be appreciated that the region of interest may be rectangle, or any suitable region of interest which comprises an area less than the total area of a video frame of the video data. The region of interest therefore comprises an amount of visual information corresponding to the particular number of pixels, distributed over a smaller area than that of a full frame of the video data, and when encoded at the particular resolution, can therefore represent the region of interest at a greater level of perceptual quality and detail than that represented in the first plurality of encoded frames.

The present disclosure may, in some examples, be implemented as part of a video conference software application. By way of example, in a video conference scenario, an encoded video stream from user devices participating in the video conference may be communicated among other of the participating devices by way of the video conference software application, each frame of the video stream comprising a head and upper torso of the corresponding user. The video conference software application may be configured to display a visually enhanced, or close-up, view of the head and upper torso of a participating user when the participating user is talking, the enhanced, or close-up, view therefore commonly termed a “talking head”. In some such examples therefore, the identifying the region of interest may be initiated based at least in part on determining that the video data has transitioned from depicting a participant in a video conference who is silent, to depicting the participant speaking. In some examples therefore, the identifying the region of interest may be initiated by any suitable trigger. The region of interest in some such examples may comprise the head and upper torso of the user, and may for example be identified using any suitable facial recognition or object recognition and tracking process or technique.

In some examples, the identifying the region of interest may be based on the output of a trained machine learning model, and may in some examples comprise providing one or more video frames of the video stream as an input to a machine learning model, and receiving as an output, from the machine learning model, data indicating the region of interest comprising the particular number of pixels based on the input video frames. The machine learning model may be trained on a training dataset comprising historic data of video streams and corresponding identified regions of interest of the video streams. The corresponding identified regions of interest in the video streams may be identified in any suitable manner, and may in some examples be user-identified or automatically identified, for example by way of any suitable machine vision process or image processing process, such as using object recognition or saliency analysis.

In some examples, the identifying the region of interest may be initiated based at least in part on accessing, determining or receiving instructions, such as from a user, the instructions indicating a selection of the region of interest.

In some examples, the particular number of pixels is arranged as an area (e.g., a rectangle) of pixels having a fixed height and a fixed width. In some examples the region of interest comprises a fixed size area of pixels, such as a rectangle of pixels, wherein the respective position of the area is different in different respective frames of the video data. The region of interest may therefore be configured to move position across multiple respective frames of the video data, which may in some examples be based on the content of the respective frames of the video data. For example, in a video conference setting in which the region of interest may be identified based on a facial recognition process, the region of interest may be configured to move with the identified face of a user, across different respective frames of the video data. Examples will be appreciated wherein the region of interest does not move.

In some examples, the first device may identify more than one such region of interest, each region of interest comprising the particular number of pixels. The particular number of pixels may be any number of pixels, for example forming a pixel array having fixed dimensions. The region of interest may be identified in any suitable manner, for example based on a region of interest identification process, such as a predefined object recognition or facial recognition process, a dynamic object recognition process such as based on a saliency analysis or machine learning process, a predefined or constant region of interest, and/or a user-selected region of interest.

The first device, such as encoding hardware thereof, may encode, based on the identified region of interest, region of interest data at the particular resolution to generate a second plurality of encoded frames, wherein each frame of the second plurality of frames has the particular number of pixels. By encoding the region of interest data at the particular resolution (e.g., 230,400 pixels arranged in 640×360 rectangle), the second plurality of encoded frames may therefore comprise a greater level of detail and perceptual quality of the region of interest spread over the same width and height, or dimensions, when compared with the encoding of the video data at the particular resolution to generate the first plurality of encoded frames. The second plurality of encoded frames may therefore represent the region of interest with fewer instances of compression effects, such as possible compression-related loss or compression artifacts, when compared with the corresponding region of the first plurality of encoded frames.

In some examples, the encoding the second plurality of frames may comprise encoding a first frame of the second plurality of frames to be decodable based at least in part on decoding and upscaling a second frame of the first plurality of frames. Frames of the upscaled first plurality of decoded frames may therefore, in some examples, provide a reference frame for decoding the second plurality of frames. In examples wherein there upscaling of the first plurality of decoded frames is based on a scale or proportion of the region of interest relative to the corresponding full frame of the video data, the upscaled first plurality of decoded frames may provide reference frames at an appropriate scale for decoding the second plurality of encoded frames.

In some examples, the first plurality of encoded frames may comprise at least one first intra coded frame and a first set of inter-coded frames, wherein each frame of the first set of inter-coded frames may be decodable based on decoding of one or more other frames of the first plurality of frames. In some examples therefore, one or more of the first plurality of encoded frames may be generated using inter-prediction encoding, wherein the inter-prediction encoding uses one or more reference frames selected from among the first plurality of encoded frames, such as the first intra-coded frame. In some examples the first plurality of encoded frames may therefore be decodable using reference frames from only the first plurality of encoded frames.

In some examples, the second plurality of encoded frames may comprise a second set of inter-coded frames, wherein each frame of the second set of inter-coded frames may be decodable based on decoding one or more other frames of the first plurality of frames and/or one or more other frames of the second plurality of frames. In some examples therefore, one or more of the second plurality of encoded frames may be generated using inter-prediction encoding, wherein the inter-prediction encoding uses one or more reference frames selected from among the first plurality of encoded frames and/or one or more reference frames selected from among the second plurality of encoded frames. In some examples, the second plurality of encoded frames may therefore be decodable using reference frames from the first plurality of encoded frames, the second plurality of encoded frames, or any combination thereof.

The first device, such as signal transmission hardware thereof, may transmit the first plurality of encoded frames and the second plurality of encoded frames to a second device for decoding. The second device may be any suitable device configured to receive the transmitted first and second plurality of encoded frames. The second device may be configured to decode the first plurality of frames and the second plurality of frames using a single decoder. It will be appreciated that the second device may configured to decode the first plurality of frames and the second plurality of frames at the particular resolution using the single decoder. Use of a single decoder, such as a single decoder setting thereof, to decode the first plurality of frames and the second plurality of frames at the particular resolution may act to streamline the decoding pipeline by removing the need for multiple decoding instances (and by extension multiple encoding instances). The reduced need for encoder and decoder level switching therefore reduces the resource pressures associated therewith. The second device may be further configured to generate for output an output video based at least in part on the first plurality of decoded frames and the second plurality of decoded frames.

In some examples, the second device may be configured to decode the first plurality of frames and the second plurality of frames using the same decoder setting of the single decoder. The term “decoder setting” will be understood within the context of the present disclosure as referring to any suitable individual adjustable parameter or configuration option applied within a decoder to control or influence the characteristics or quality of a decoder output. The term “single decoder setting” will therefore be understood as denoting the selection of one fixed parameter or group of parameters. In some examples, the single decoder setting may be resolution, but examples will be appreciated wherein the single decoder setting may be any fixed one or more parameters or decoder configuration, including but not limited to, bitrate, frame rate, color depth, compression mode, or any codec-specific feature. The single decoder setting may directly affect the resulting performance, quality, or efficiency of the decoding process and may in some examples be selected based on any suitable constraint, such as network bandwidth, or based on any suitable application requirements.

In some embodiments, a first device may receive a first plurality of video frames of a video stream encoded at a particular resolution, wherein each frame of the first plurality of video frames comprises a particular number of pixels (e.g., arranged in a rectangular area having a width and a height). The first device may receive a second plurality of video frames encoded at the particular resolution, wherein the second plurality of video frames is based on data corresponding to a region of interest of the first plurality of video frames, wherein each frame of the second plurality of video frames comprises the particular number of pixels (e.g., having the same width and height as the frames of the first plurality of frames). The first device may be any suitable device configured to receive the first and second plurality of video frames of the video stream. The receiving of the first and second plurality of video frames may be from any suitable device, for example an encoding device.

A decoder, for example decoding hardware of the first device, when operating with particular settings, may decode the first plurality of encoded video frames. The particular settings may be any suitable decoder setting or settings as described herein. An upscaling process, for example performed by the first device, may be used to upscale the first plurality of decoded frames. Any suitable upscaling process will be envisaged as described herein, and may comprise upscaling the first plurality of decoded frames based on a scale or proportion of a region of interest identified within a frame of video data to be encoded.

A decoder, for example decoding hardware of the first device, when operating with the particular settings, may decode the second plurality of encoded video frames. Any suitable display or rendering device, for example of the first device, may generate, for display, a composited video generated at least in part based on compositing each respective frame of the upscaled first plurality of decoded frames with a respective frame of the second plurality of decoded frames. The first plurality of frames, the second plurality of frames, and/or each frame thereof, may be encoded to comprise metadata, for example in a header thereof, defining the position of each respective frame of the second plurality of decoded frames relative to the corresponding upscaled first plurality of decoded frames in the composite frame. The compositing may, in some examples be performed based on the metadata.

In some embodiments described herein the decoder device uses only a single encoder and decoder level (e.g., encoded and decoded at a single resolution or frame size), and may thereby avoiding the need for level switching of the encoder and decoder during streaming.

Encoding a region of interest within a video frame of the stream at the same resolution as other video frames of the stream, for decoding and playing, or for decoding and compositing within an upscaled video frame of the stream before playing, may enable the focusing of visual enhancement resources toward regions of interest within the video frames, and may reduce unnecessary enhancement of other regions of the video frame, while maintaining the use of only a single encoder and decoder level.

The present disclosure therefore propagates visually enhanced region of interest data within an encoding and decoding pipeline at the same resolution as whole video frame data without requiring encoder and decoder level-switching, thereby providing a stream quality which is robust to changes in network bandwidth without the resource pressure of multiple encoding and decoding instances. In some applications, such as a video conference setting, switching between a whole video frame and a visually-enhanced region of interest frame, such as a “talking head”, may therefore be implemented without requiring multiple encoding and decoding instances, and the computational overhead associated with encoder and decoder level switching.

In some examples, the second device may be further configured to upscale the first plurality of decoded frames. The upscaling of the first plurality of decoded frames may be performed in any suitable manner, and the upscaling may, for example, be used to provide upscaled first plurality of decoded frames based a relative scale or proportion of the region of interest. For example, the identified region of interest may comprise a scale or proportion relative to the corresponding full video frame of the video data. The upscaling of the first plurality of decoded frames may in some examples be based on the scale or proportion of the identified region of interest relative to the corresponding full video frame of the video data. By upscaling the first plurality of decoded frames based on the corresponding scale or proportion of the region of interest, the second plurality of decoded frames characterizing the region of interest may be composited with the upscaled first plurality of decoded frames to provide a composite frame.

Therefore, in some examples, the second device may be further configured to perform the compositing of each respective frame of the upscaled first plurality of decoded frames with a respective frame of the second plurality of decoded frames.

In some such examples, the generating for output the output video may be based at least in part on the compositing. By compositing the second plurality of decoded frames with the upscaled first plurality of decoded frames, composite frames of the output video may be provided which comprise the visually enhanced region of interest, without imparting any potential visual effects of an upscaling process on the visually enhanced region of interest. The improved visual detail and perceptual quality of the region of interest, of the second plurality of decoded frames, may therefore persist in the composite frames, and subsequently the output video. It will be appreciated that one or more of the upscaling and compositing may be performed as in-loop or out-of-loop processes relative to a decoding pipeline, and may in some examples be performed by corresponding hardware or software elements.

It will be appreciated that any process steps and functionality of the present disclosure, in any suitable combination thereof, may be performed on a client device, such as a user device, or at one or more servers. The performance of steps or functionality at a server may in some cases act to conserve memory and computational processing resources on a client device.

It will be appreciated that any features described herein as being suitable for incorporation into one or more aspects, embodiments or examples of the present disclosure are intended to be generalizable across any and all aspects, embodiments and examples of the present disclosure.

### BRIEF DESCRIPTION OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

The embodiments herein may be better understood by referring to the following description in conjunction with the accompanying drawings, in which like reference numerals indicate identical or functionally similar elements, of which:

FIG. 1A depicts initial steps of an illustrative process for providing an enhanced stream of digital content from a first device to a second device, in accordance with some embodiments of this disclosure;

FIG. 1B depicts further steps of the illustrative process for providing an enhanced stream of digital content, of FIG. 1A, in accordance with some embodiments of this disclosure;

FIG. 1C depicts further steps of the illustrative process for providing an enhanced stream of digital content, of FIG. 1A and FIG. 1B, in accordance with some embodiments of this disclosure;

FIG. 2 depicts steps of an illustrative process for receiving an enhanced stream of digital content at a second device from a first device for decoding and displaying, in accordance with some embodiments of this disclosure;

FIG. 3 is a flowchart of an illustrative process for providing an enhanced stream of digital content from a first device to a second device for decoding and displaying, in accordance with some embodiments of this disclosure;

FIG. 4 depicts an illustrative example of a raw video data, a first decoded layer of frames and a second decoded layer of frames for generating an enhanced stream of digital content, in accordance with some embodiments of this disclosure;

FIG. 5 shows an example frame structure of an encoded video stream, in accordance with some embodiments of this disclosure;

FIG. 6 shows an alternate example frame structure of an encoded video stream to that shown in FIG. 5, in accordance with some embodiments of this disclosure;

FIG. 7 shows a further alternate example frame structure of an encoded video stream, in accordance with some embodiments of this disclosure;

FIG. 8 shows an example video conferencing scenario, in accordance with some embodiments of this disclosure;

FIG. 9 shows an example media content consumption scenario, in accordance with some embodiments of this disclosure;

FIG. 10 shows illustrative devices and systems for providing an enhanced stream of digital content, in accordance with some embodiments of this disclosure; and

FIG. 11 shows illustrative devices and systems for providing an enhanced stream of digital content, in accordance with some embodiments of this disclosure.

### DETAILED DESCRIPTION

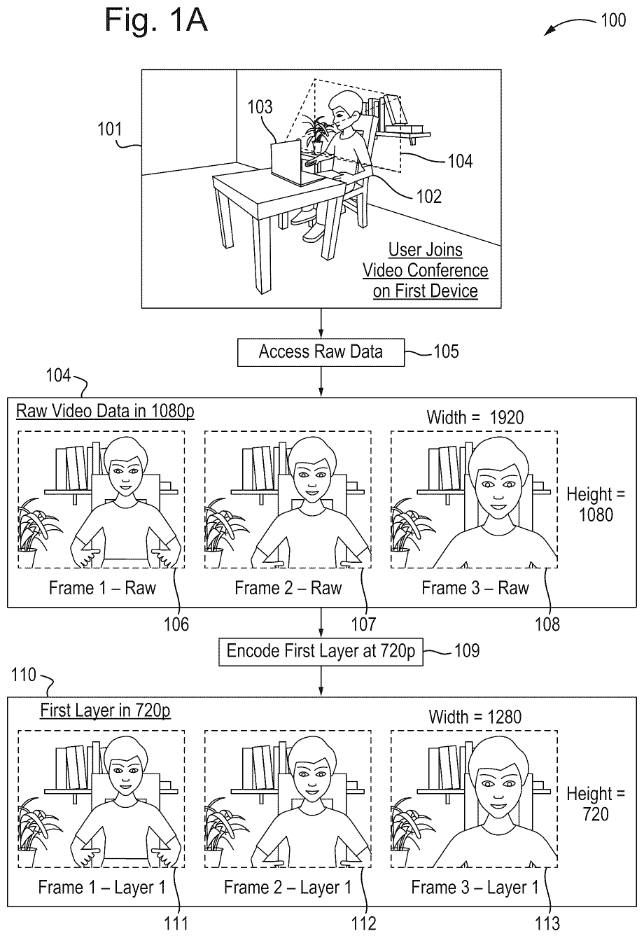

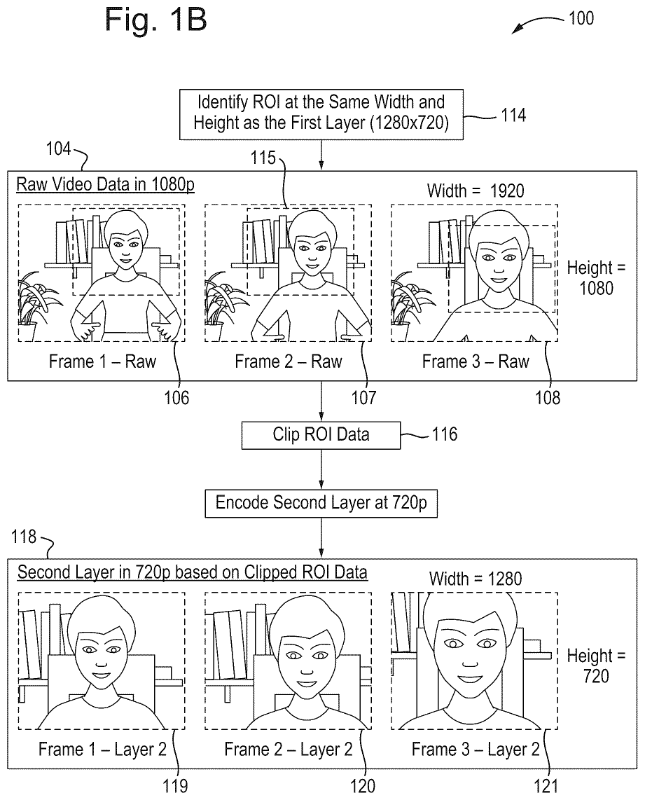

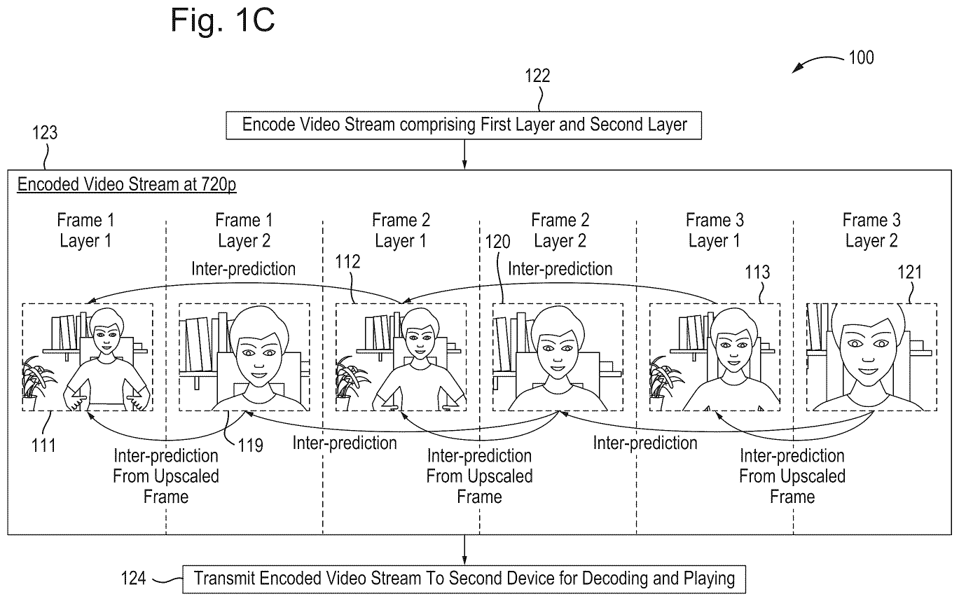

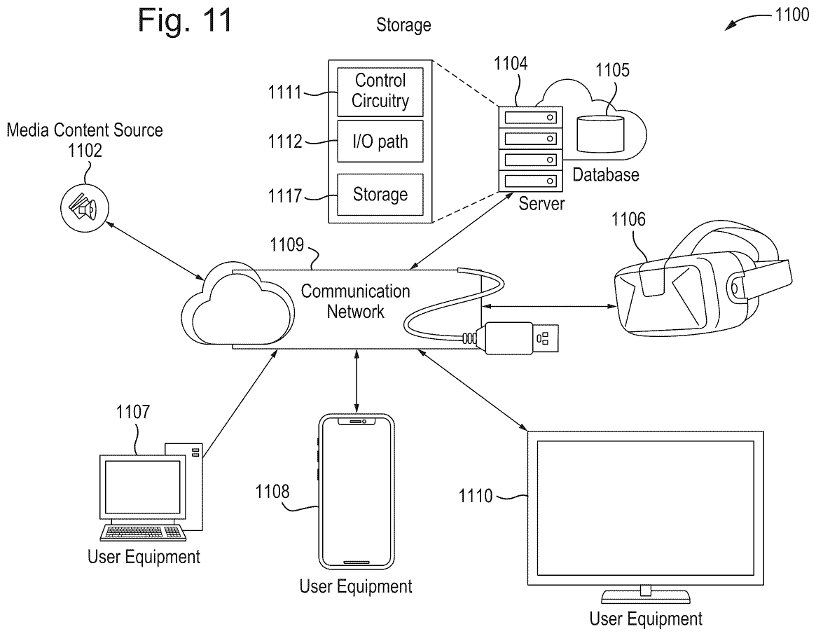

FIG. 1A shows initial steps of an illustrative scenario 100 in which raw video data (e.g. data captured during a video conference or accessed for encoding for a video stream) is accessed and encoded with a stream of digital content at a first device, for transmitting to a second device for decoding and playing, in accordance with some embodiments of this disclosure. The raw video data may be accessed or received in any suitable format. For example, each frame of the raw video data may be represented by one or more uncompressed matrices or arrays of pixel data having a pixel width and a pixel height corresponding to the frame resolution (e.g., 1920 pixels by 1080 pixels at 1080p resolution), the pixel data defining one or more visual characteristics of pixels at the corresponding locations in the matrices. The pixel data may, for example, define for each pixel, a pixel color (e.g., by way of RGB values), and one or more additional channels representing visual characteristics such as alpha, luminance, chrominance, hue, saturation, value, bit-depth, dynamic range, gamma, and color space. Any suitable combination of visual characteristics will be envisaged. The first device and the second device may be any suitable device (e.g., a device of a user 1106, 1107, 1108, 1110 of FIG. 11) having processing capability for performing steps of an encoding and decoding pipeline, and connectivity to a communications network (e.g., communication network 1109 of FIG. 11) facilitating the transmission of streamed video data (e.g., encoded video data) between the first device and the second device. The transmission of the streamed video data may be performed directly between the first device and the second device, or by way of one or more intermediary devices (e.g., one or more servers 1104 of FIG. 11) or by using any suitable computer network (e.g., Internet, cellular network, etc.), the one or more intermediary devices optionally configured to perform any suitable portion of an encoding and decoding pipeline as described herein, for example one or more portions of a video frame enhancement process.

In some embodiments, the first device and the second device may each implement a respective software application running on a hardware platform, each respective software application associated with instructions stored at a non-transitory storage of the corresponding device, the instructions configured when executed on the device to perform encoding functionality or decoding functionality. In some embodiments, the software application may be implemented via any combination of a server and user device (e.g., server 1104 and/or any of user equipment 1106, 1107, 1108, 1110). Referring to FIG. 1A, the software application is, for example, a live video conferencing application configured to implement a live video conference between participating user devices. Examples will be appreciated wherein any suitable software application is implemented (e.g., an OTT streaming application between a media content source 1102 or server 1104 and user equipment 1106, 1107, 1108, 1110).

Returning to FIG. 1A, in a first step 101 of the process 100, a user 102 operates a first computing device 103 (e.g., a laptop) running the video conferencing software application, to join a live video conferencing session occurring between multiple such user devices, and optionally facilitated by one or more servers. The first device 103 may connect to the live video conference by way of a communication network (e.g., communication network 1109), which may comprise one or more interconnected networks and may include, for example, the Internet, local-area networks (LAN), wide-area networks (WAN), wireless networks (e.g., Wi-Fi networks, cellular networks including 3G, 4G/LTE, 5G, or later generation networks), wired networks (e.g., Ethernet), satellite networks, or any suitable combination thereof. The one or more servers (e.g., server 1104) may include any combination of application servers, media servers, relay servers, conferencing bridges, cloud computing infrastructure, content delivery networks (CDN), edge computing nodes, or any suitable combinations thereof. For example, the user devices may initiate communication via a software application installed locally on each respective device, establishing a secure session (e.g., through encryption protocols such as Transport Layer Security (TLS), Secure Real-Time Transport Protocol (SRTP), or other secure protocols) with one or more remote servers. These servers may manage and route audio and video data streams among the user devices participating in the live video conferencing session.

Alternatively or additionally, the computing device 103 may directly exchange video and audio data streams with other participant user devices using peer-to-peer (P2P) connections, which may be mediated, or initially negotiated, by one or more networked servers (such as signaling or coordination servers employing WebRTC protocols or similar technologies). The live video conference may therefore be implemented using client-server architectures, peer-to-peer architectures, or a hybrid architecture employing elements of both, depending on various considerations such as scalability, latency, security, and network efficiency.

At 101, at any suitable point during the video conference, the first computing device 103 may be configured to capture raw video data and/or audio data by way of local input devices (e.g., one or more microphones and/or cameras integrated therein or connected thereto). In FIG. 1A, the raw video data comprises video data 104 captured of the head and upper torso of the user by an on-device camera of the first device 103, for use during the live video conferencing session. The video data 104 captured by the on-device camera of the first device 103 is captured in an uncompressed, raw video data format (e.g., RAW, TIFF, MOV, among others as will be appreciated), at a predetermined or dynamically adjusted frame rate (e.g., 60 frames per second), each frame captured at a capture resolution of 1080p (1920×1080 pixels), but any suitable frame rate and capture resolution will be appreciated. At 105, the first device 103 may be further configured to access the captured raw video data comprising a plurality of video frames thereof, including a first video frame 106, a second video frame 107, and a third video frame 108 captured in sequence. Across a capture duration, over which the first, second and third video frames 106, 107, 108 are captured, the user may move their head and torso as depicted.

At 109, the first device 103 may be configured to encode, using encoding hardware or software thereof, the accessed video frames 106, 107, 108 of the raw video data 104 as a first layer 110 comprising corresponding encoded first, second and third video frames 111, 112, and 113 encoded at a particular resolution (e.g., 720p, or 1280×720 pixels, as shown in FIG. 1A). Any suitable particular resolution will be envisaged (which may, for example, be in accordance with a predetermined scaling factor relative to the capture resolution), for example, 480p or 720×480 pixels, 720p or 1280×720 pixels, 1080p or 1920×1080 pixels, or 4K UHD or 3840×2160 pixels. The encoding hardware or software may be configured to compress the raw video data 104 into the digitally encoded first layer 110 suitable for efficient transmission over the communication network. The encoding process may employ any suitable video codec, compression standard, or algorithm, including but not limited to H.264 (AVC), H.265 (HEVC), AV1, VP8, VP9, or other video compression codecs or standards. Any suitable intra-coding and inter-prediction encoding may be performed in the encoding of the first layer 110, such that any frame of first layer may be decoded using one or more reference frames of the first layer 110. Any suitable group of pictures (GOP) structure may be used for the first layer, comprising any suitable combination of independently decodable frames (e.g., I-frames, key frames, IDR frames, among others as will be appreciated), P-frames and B-frames.

The raw video data 104 may be encoded at the particular spatial resolution (720p) in accordance with a particular encoder setting, which may be predetermined or dynamically selected based on any suitable parameters or conditions. For example, the particular resolution may be selected based on a network bandwidth availability or processing capability of the first device 103 or of one or more second participating devices. In some examples, the particular resolution may be selected based on one or more user preferences or application-specific requirements, or any combination thereof. In some examples, the particular spatial resolution may be associated with a scale or proportion relative to the resolution of the captured raw video data.

FIG. 1B shows further steps of the illustrative scenario 100, which may follow the initial steps described in relation to FIG. 1A, be performed substantially simultaneously thereto, or be performed in any suitable order relative thereto as will be appreciated. At 114, the first device 103 may identify a region of interest 115 in each frame 106, 107, 108 of the raw video data 104, the region of interest 115 of each frame 106, 107, 108 having the same number of pixels (represented as the same width and height) as the spatial resolution (720p or 1280×720 pixels) of the corresponding encoded frames 111, 112, 113 of the first layer 110. The region of interest may be any suitable region of interest, and may be identified based on, or using, any suitable region of interest identification process or protocol, such as described herein. In FIG. 1A, the region of interest 115 is identified based on a predefined facial recognition process of the video conferencing software application, and the region of interest therefore represents a close-up view of the face of the user 102, relative to the raw video data 104. As described, the face and torso of the user 102 may move position relative to the first device 103 during the capturing of the raw video data 104 such that the region of interest 115 identified in each respective frame 106, 107, 108 of the raw video data 104 is at a different corresponding position within the respective video frame 106, 107, 108 as shown in FIG. 1B.

At 116, the first device 103 may be configured to isolate, clip or crop region of interest data representing the region of interest 115 from the corresponding frames 106, 107, 108 of the raw data 104. For example, given an illustrative raw uncompressed video frame captured at 1080p resolution, having a size of 1920×1080 pixels, a region of interest may be identified as a rectangular area having the same number of pixels (represented as the same width and height) as the spatial resolution (720p or 1280×720 pixels) of the corresponding encoded frames 111, 112, 113. The rectangular area of the illustrative example region of interest may therefore be selected having top-left pixel coordinates of [320, 275] and bottom-right pixel coordinates of [1600, 995], the rectangular area thereby forming a submatrix of size 1280x720 pixels (720p resolution). At 117, the first device 103 may be configured to encode, using encoding hardware or software thereof, the isolated, clipped or cropped region of interest data of each frame 106, 107, 108 of the raw video data 104 as an encoded second layer 118 comprising corresponding encoded first, second and third video frames 119, 120, and 121 encoded at the same particular resolution (e.g., 720p, or 1280×720 pixels, as shown in FIG. 1B) as that used to encode the first layer 110. The encoding hardware or software therefore encodes the second layer 118 using the same particular encoder setting as that used to encode the first layer 110, and only a single encoding instance is therefore required, using a single encoder level. As will be appreciated, the encoding of the second layer may be performed in any suitable manner as described in relation to the encoding of the first layer 110. In particular, the encoding of each frame 119, 120, 121 of the second layer may be performed using any combination of intra-coding or inter-prediction encoding, and may in some examples comprise using one or more of the corresponding frames 106, 107, 108 of the raw video data 104 as reference frames for the encoding.

The intra-coding and inter-prediction encoding may be performed in any suitable manner and in accordance with any suitable encoding standard (e.g., H.264/MPEG-4 AVC (Advanced Video Coding), H.265/HEVC (High Efficiency Video Coding), AV1 (AOMedia Video 1), and VP9 (Video Processor 9)). The encoding process typically comprises a number of discrete steps such as frame partitioning and block division, transformation and quantization, and entropy encoding, with inter-prediction encoding comprising steps such as prediction and motion estimation. In frame partitioning and block division, a raw video frame is typically partitioned into smaller, blocks or macroblocks (e.g., 8×8 pixels, 16×16 pixels, or larger coding units), each block processed individually during encoding. For transformation and quantization steps, a reduction in spatial redundancy may be performed using transformations, such as the Discrete Cosine Transform (DCT), and converting spatial pixel data into frequency coefficients. Such coefficients may then be quantized, thereby discarding visual data, such as less visually important data. In entropy encoding, the quantized coefficients and other compression metadata (e.g., motion vectors, frame headers, etc.) are further compressed using one or more entropy encoding techniques, such as Huffman coding or arithmetic coding, which may be used to exploit statistical redundancy in the raw video frame data. In inter-prediction encoding, the prediction and motion estimation processes may include a reduction in temporal redundancy by predicting frame content based on one or more previous or future frames, identifying corresponding motion vectors, and encoding only differences between frames.

The encoding process may, in some examples include one or more pre-processing steps such as color space conversion or chroma subsampling. In color space conversion processes, raw frames may be converted, such as from RGB to YCbCr color space, separating luminance information (brightness) from chrominance (color) information to enable efficient compression. Chroma subsampling may include reduction in color information (such as that contained in one or more chrominance channels), such as from 4:4:4 to 4:2:0. The color information reduction may leverage the limited sensitivity of the human visual system to fine color details in order to improve compression without a perceivable quality reduction.

In some examples, one or more encoded frames 111, 112, 113 of the encoded first layer 103 may be upscaled (which may, in some examples, comprise decoding the first layer frames) and the upscaled first layer frames may be used as reference frames for encoding the corresponding second layer frames 119, 120, 121, in any suitable manner.

FIG. 1C shows further steps of the illustrative scenario 100, which are configured to follow the steps described in relation to FIG. 1A and FIG. 1B. At 122, the first device 103 is configured to construct an encoded video stream 123 comprising the first layer 110 and the second layer 118 video frames. The respective reference frame dependencies of the constructed video stream 123 are shown depicted in FIG. 1C. The first device 103 may be further configured to, at 124, transmit the encoded video stream 123 to one or more second participant devices of the live video conferencing session by way of the communication network. It will be appreciated that, concurrently, the first device 103 may be configured to receive encoded video data streams and audio data streams from one or more of the second participant devices of the live video conference, and may be configured to decode and render the video data streams for displaying locally, thereby enabling real-time interactive communication among all participant devices.

It should further be understood that while the depicted scenario 100 specifically illustrates a computing device 103 joining a video conferencing session, similar principles may be extended to other forms of media consumption or collaboration, including real-time document collaboration, content streaming, screen sharing, messaging, extended reality (XR) experiences such as virtual reality (VR) or augmented reality (AR), or other interactive applications facilitated via similar data communication architectures.

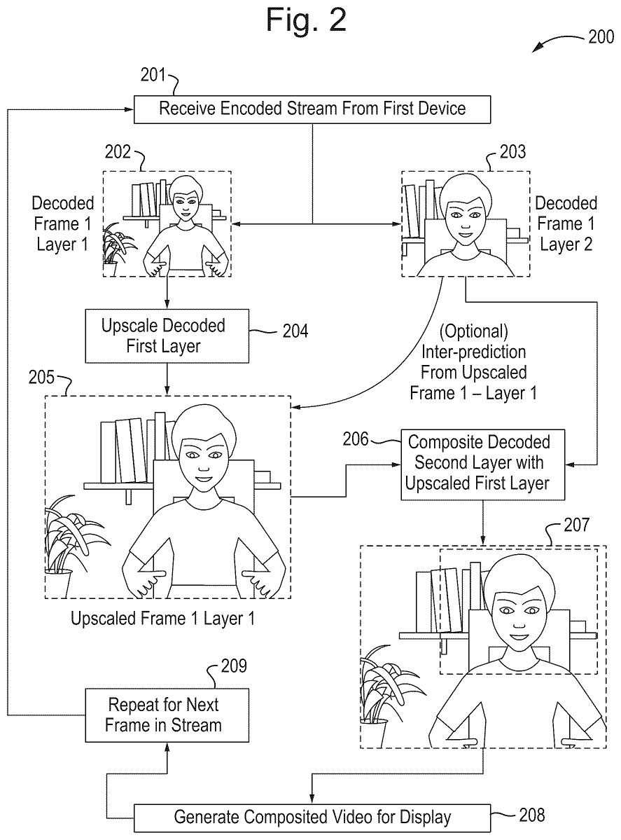

FIG. 2 shows steps of an illustrative scenario 200 (for example, this can follow the illustrative scenario 100 of FIGS. 1A-1C). A second participating device of the video conference session receives, at 201, an encoded video stream (e.g., encoded video stream 123) from a first device (e.g., first device 103), for the purpose of decoding and playing the video stream at the second device. The second device may be configured to decode each respective frame (e.g., frames 111, 119, 112, 120, 113, 121) of the encoded video stream using any suitable decoder hardware or software thereof. The decoding may, for example, follow an interleave decoding process during which a decoded first frame 202 of a first layer (e.g., first layer 110) may be followed by the decoding of a corresponding second frame 203 of a second layer (e.g., second layer 118). Since the frames of the first layer and the second layer are encoded at the same resolution, the decoding is performed using the same decoder setting and may therefore be performed using a single decoding instance, thereby avoiding decoder level switching.

The decoded first frame 202 may be decoded using any suitable decoding, which may be intra-decoding or inter-prediction decoding using one or more reference frames of the first layer. The second device may be configured to, at 204, upscale the decoded first layer frame 202 to provide an upscaled decoded first layer frame 205. The upscaling process may be performed in any suitable manner as will be appreciated, and may for example be performed based on a relative scale or proportion of the particular resolution of the encoded first layer to the capture resolution of the raw video data (e.g., raw video data 104).

The decoding of the corresponding second layer frame 203 may be performed in any suitable manner and may include be intra-decoding or inter-prediction decoding using one or more reference frames of the first layer or the second layer. Optionally, the decoding of the second layer frame 203 may be performed at least in part by way of inter-prediction using the upscaled decoded first layer frame 205. The decoding of the second layer frame 203 may thereby make use of a corresponding scale of the upscaled decoded first layer frame 205 during the decoding, which may improve inter-prediction accuracy and reduce instances of compression artefacts.

At 206, the second device may be configured to perform a compositing of the upscaled decoded first layer frame 205 and the corresponding decoded second layer frame 203 to provide a corresponding composited frame 207. By way of example, the second layer frame may represent a 1280×720 pixel (720p) rectangular region of interest isolated from a raw uncompressed video frame captured at 1080p resolution, having a size of 1920×1080 pixels, at top-left pixel coordinates of [320, 275] and bottom-right pixel coordinates of [1600, 995]. The first layer frame, encoded at the same resolution (720p) as the second later frame, may be decoded and upscaled by a scale corresponding to a scale of the isolated region of interest relative to the raw uncompressed video frame. The scale of a 720p region of interest relative to a 1080p raw uncompressed video frame is 1:2.25. Therefore, by upscaling the first layer frame by the scale of 2.25, the decoded second layer frame may be positioned relative to the decoded and upscaled first layer frame at the same top-left pixel coordinates of [320, 275] and bottom-right pixel coordinates of [1600, 995] to form a composite frame. Any suitable decoding, upscaling and compositing process will be appreciated, and in some examples a position detection process may be performed to determine a corresponding positioning of the decoded second layer frame relative to the decoded and upscaled first layer frame. In the composited frame 207, the decoded second layer frame 203 is positioned, by any suitable compositing process or software, relative to the upscaled decoded first layer frame 205 such that the decoded second layer frame 203 provides a region of improved detail and perceptual quality within the composited frame 207. In some examples, metadata associated with the encoded first layer frames and/or the corresponding encoded second layer frames (for example as part of a header thereof) may define the position, such as the pixel coordinates, of the decoded second layer frames relative to the corresponding upscaled decoded first layer frames. At 208, the second device may be configured to use the sequentially composited frames 207 to construct a composited video for displaying at the second device, before, at 209, repeating the process 200 for one or more subsequent encoded frames in the received encoded video stream (e.g., encoded video stream 123). The upscaling and compositing may be performed by any suitable in-loop or out-of-loop process relative to the decoding process of the second device.

As such, in the described video conferencing session (with reference to the examples 100, 200), region of interest data of captured raw video data may be used to visually enhance a prioritized portion of a video stream (which in some examples is an identified face of a video conference participant), without visual enhancement of unnecessary regions of the video frames and while making use of a single encoder and decoder setting, thereby avoiding the resource pressures or encoder and decoder level switching common to ABR streaming and scalable video coding (SVC) techniques.

In some examples, the identifying of the region of interest in the raw video data may be performed in response to any suitable region of interest trigger. The region of interest trigger may, for example, be received in response to the detection of audio at the first device (e.g., first device 103), for example at a volume which is greater than a threshold volume. In some videoconferencing scenarios, the detection of audio at a user device may trigger the highlighting of a display of the corresponding user at one or more second participating devices. Such a highlighting of the display of the user may comprise a visually enhanced display of the user. The detection of the audio, for example at a volume greater than a volume threshold, may therefore provide such an example region of interest trigger configured to initiate the identification of the region of interest at the first device, and the subsequent encoding of the second layer of the encoded video stream. Any other suitable region of interest trigger will be appreciated based on the present disclosure, and may for example be based on a specific application or use-case. For example, a user streaming video footage may elect to receive a particular region of the streamed footage at a higher level of detail or perceptual quality. The election of the region of the streamed footage by the user may provide both the region of interest trigger, together with region of interest data defining the elected region of interest to be isolated, clipped or cropped from the raw video data. In another example, a user viewing streamed content, such as a live stream of a baseball game, may in response to poor network bandwidth, elect to receive only the scoreboard in enhanced detail or perceptual quality. The election of the scoreboard by the user may provide both the region of interest trigger, together with region of interest data defining the elected region of interest to be isolated, clipped or cropped from the raw video data. Other examples will be appreciated within the scope of the present disclosure, and may for example comprise more than one region of interest, or one or more regions of interest which are automatically determined, for example based on a trained machine learning model or any suitable image processing or object recognition technique, or as a result of a context or saliency analysis.

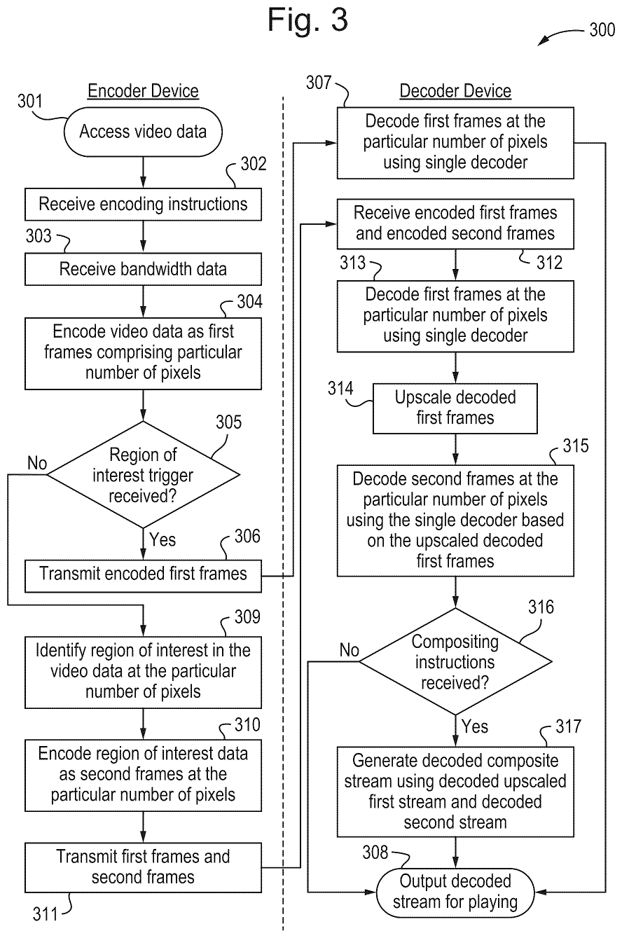

FIG. 3 is a flowchart of an illustrative process 300 in which raw video data is received and encoded as an enhanced stream of digital content at a first device, for transmitting to a second device for decoding and playing, in accordance with some embodiments of this disclosure. In various embodiments, the individual steps of process 300 may be implemented by one or more components of the devices and systems of FIGS. 1, 2, 10 and 11 comprising encoder and/or decoder functionality, e.g., the first device 103 of FIGS. 1A-C and the second device of FIG. 2. Although the present disclosure may describe certain steps of process 300 (and of other processes described herein) as being implemented by certain components of the devices and systems of FIGS. 1, 2, 10 and 11, this is for purposes of illustration only, and it should be understood that other components of the devices and systems of FIGS. 1, 2, 10 and 11 may implement those steps instead.

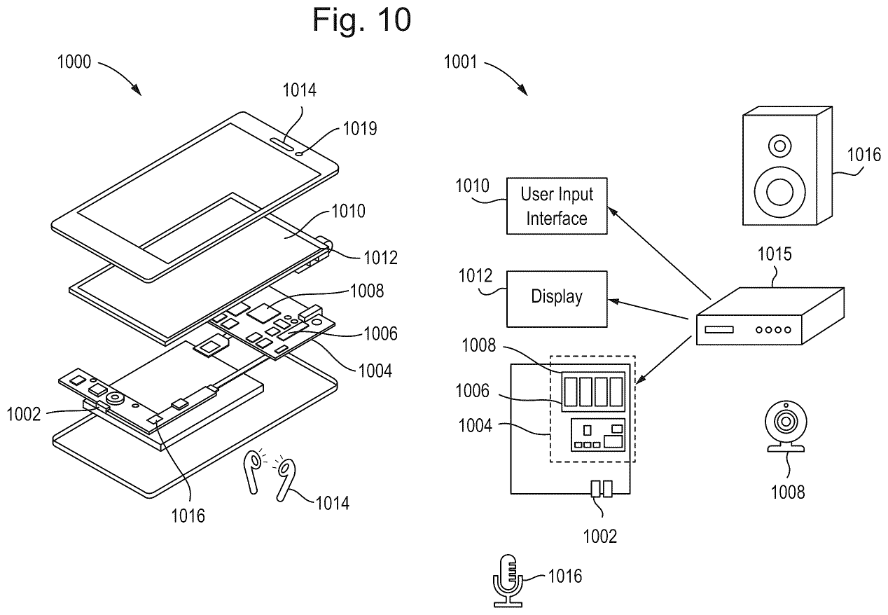

At 301, an input/output circuitry (e.g., I/O path 1002 of FIGS. 10, 1112 of FIG. 11) of an encoder device (e.g., the first device 103 of FIGS. 1A-1C, user equipment 1106, 1107, 1108, 1110) may access video data, for example by way of a video capture device or by way of any suitable memory or storage device (e.g., storage 1008 of FIGS. 10, 1117 of FIG. 11). The encoder device may be any suitable device having encoding functionality, and may for example be a user device (e.g., first device 103, user equipment 1106, 1107, 1108, 1110) or a server (e.g., server 1104). In some examples, at 302, the encoder device, for example the input/output circuitry, may receive instructions, such as by way of a communication network (e.g., communication network 1106), to encode the accessed video data, which may be in accordance with a particular encoder setting which may be determined in any suitable manner as described herein, such as for example at 303, in response to receiving, such as by the input/output circuitry, network bandwidth information indicating an available network bandwidth of the encoder device.

Following the accessing of the video data 301, control circuitry (e.g., control circuitry 1004 of FIGS. 10, 1111 of FIG. 11) of the encoder device may be configured to, at 304, encode the video data as a first plurality of frames comprising a particular number of pixels (arranged in a rectangular area having a width and height), the encoding performed using the particular encoder setting, such as defining a particular resolution of the encoding. The particular resolution may be any suitable resolution as described herein, and may in some examples be based on the received network bandwidth information. The encoding of each frame of the first plurality of encoded frames may be performed in any suitable manner, and may for example comprise a combination of intra-coding and inter-prediction encoding based on one or more reference frames of the first plurality of frames.

At 305, the control circuitry may be configured to determine whether a region of interest trigger is received at the encoder device, for example by way of the input/output circuitry over the communication network. By way of example in reference to the scenario described in relation to FIGS. 1A-2, the region of interest trigger may be the detection of audio at a user device (e.g., the first device 103, user equipment 1106, 1107, 1108, 1110) at a volume which is greater than a threshold volume. The detection may provide a positive region of interest trigger in some such scenarios. Other region of interest triggers will be appreciated as described herein.

In the event that no region of interest trigger is received at the encoder device, at 306, the encoder device, for example the input/output circuitry, which may comprise signal transmission circuitry, may be configured to communicate the first plurality of encoded frames to a decoder device (e.g., second device of FIG. 2). The decoder device may be any suitable device having decoder functionality and configured to receive, at input/output circuitry thereof (e.g., I/O path 1002, 1112) the first plurality of encoded frames, for decoding and displaying. At 307, following receipt of the first plurality of encoded frames, a control circuitry (e.g., control circuitry 1004, 1111) of the decoder device may be configured to decode the first plurality of frames at the particular number of pixels, the decoding performed by a single decoder using a particular decoder setting, such as defining a particular resolution of the decoding. Following the decoding of the first plurality of encoded frames, the control circuitry of the decoder device may optionally perform any suitable visual enhancement or upscaling process on the decoded frames, before at 308, constructing and outputting, by way of the input/output circuitry, a decoded stream for playing at the decoder device, such as a display circuitry thereof (e.g., display 1012).

In the event that a region of interest trigger is received at the input/output circuitry of the encoder device, at 309, the control circuitry of the encoder device may be configured to identify a corresponding region of interest in the accessed video data, the region of interest having the particular number of pixels of the first plurality of encoded frames. At 310, the control circuitry of the encoder device may be configured to encode region of interest data corresponding to the region of interest as a second plurality of encoded frames at the particular number of pixels, the encoding performed using the same particular encoder setting as that used by the encoder device for encoding the first plurality of encoded frames. Following the encoding of the region of interest data as the second plurality of encoded frames, the input/output circuitry, which may comprise signal transmission circuitry, of the encoder device may be configured to, at 311, transmit the first plurality of encoded frames and the second plurality of encoded frames as an encoded video stream to the decoder device, for example by way of the communication network.

At 312, the input/output circuitry of the decoder device may be configured to receive the first plurality of encoded frames and the second plurality of encoded frames, and at 313, the control circuitry of the decoder device may be configured to decode the first plurality of frames. The decoder device is configured to decode the first plurality of frames at the particular number of pixels, the decoding performed by a single decoder using the particular decoder setting, such as defining the particular resolution of the decoding.

At 314, the control circuitry of the decoder device may be configured to upscale the first plurality of decoded frames, for example based on a scale or proportion of the particular resolution of the first plurality of encoded frames relative to the accessed video data. Following the upscaling, the control circuitry of the decoder device may be configured to, at 315, use the upscaled first plurality of decoded frames as reference frames for, at least in part, inter-prediction decoding corresponding frames of the second plurality of encoded frames at the particular number of pixels. The decoding of the second plurality of frames at the particular number of pixels is performed using a single decoder using the same particular decoder setting used for decoding the first plurality of encoded frames, such as defining the same particular resolution of the decoding. As such, only a single decoder is required for decoding the first and second plurality of frames, for use in providing a visually enhanced video stream.

At 316, it may be determined by the control circuitry of the decoder device whether instructions are received, such as by way of the input/output circuitry, to perform a compositing of the first plurality of decoded frames and the second plurality of decoded frames. In the event that the no such instructions are received, the input/output circuitry of the decoder device may be configured to, at 308, output the decoded first and second plurality of decoded frames as a decoded stream for playing at the decoder device, such as at a display (e.g., display 1012) thereof.

In the event that compositing instructions are received, at 317 the control circuitry of the decoder device may be configured to generate a decoded composite stream as described in relation to FIG. 2, using the upscaled first plurality of decoded frames and the second plurality of decoded frames.

As such, in the described illustrative process 300, region of interest data of captured video data may be used to visually enhance a particular portion of a video stream, without requiring visual enhancement of unnecessary regions, and while making use of a single encoder and decoder setting.

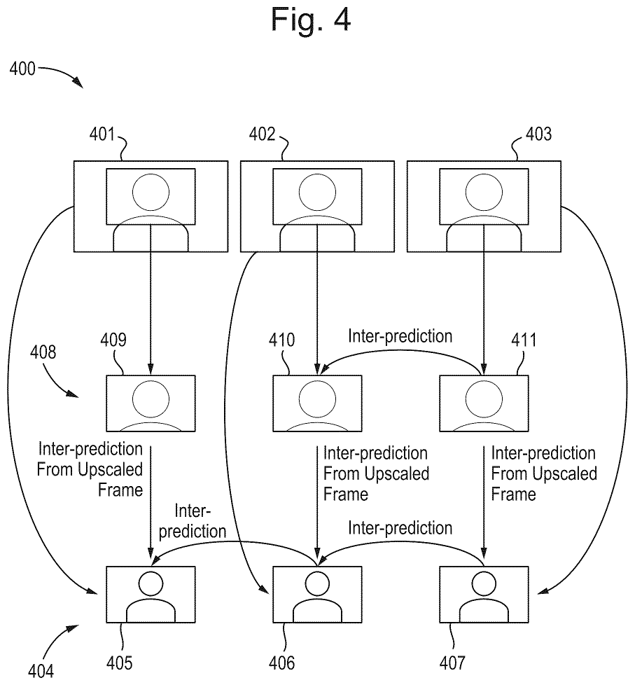

FIG. 4 shows, for illustrative purposes, the concept of providing a first layer of encoded video frames representing the full frame of raw video data, and a second layer of encoded video frames representing only a region of interest of the raw data but comprising the same number of pixels (arranged in a rectangular area having the width and height) as the encoded first layer frames. In particular, the raw video data 400 is shown depicting the capture of the head and torso of a user, such as described in relation to the illustrative examples of FIGS. 1A-2 during a video conference session. The raw data 400 comprises a corresponding first frame 401, second frame 402 and third frame 403 captured in sequence. A first layer 404 of encoded video frames, comprising a first frame 405, second frame 406 and third frame 407 corresponding to the first second and third raw data frames 401, 402, 403, are encoded at a particular resolution (720p, 1280×720 pixels), the frames 405, 406, 407 of the first layer 404 representing the full frame of the respective raw data frames 401, 402, 403 within said number of pixels. A second layer 408 of encoded video frames, comprising a first frame 409, second frame 410 and third frame 411 corresponding to the first second and third raw data frames 401, 402, 403, are encoded at the particular resolution (720p, 1280×720 pixels), the frames 409, 410, 411 of the second layer 408 representing only a region of interest selected from within the full frame of the respective raw data frames 401, 402, 403, within the same number of pixels as those of the first layer 404. The second layer frames 409, 410, 411 therefore represent higher detail and perceptual quality of the raw data 400 when compared with the corresponding frames 405, 406, 407 of the first layer 404. Therefore, by encoding the second layer frames at the same resolution as that used for encoding the first layer frames, a comparatively lower level of compression effects may be observed for the second layer when compared with the first layer. The higher detail and perceptual quality of the second layer frames may therefore persist in the decoded second layer frames, and the resultant displayed video. In some examples, the decoded first layer frames may be upscaled for compositing with the decoded second layer frames. While upscaling and visual enhancement techniques may be used to improve quality and detail of decoded frames, such processes may be limited by the quality of the input decoded frames, and may often require extensive computational resources unsuitable for some applications, such as real-time streaming scenarios. The detail and perceptual quality persisting in the decoded second layer frames may therefore act to provide a resource efficient visual enhancement of a key area of the upscaled decoded first layer frames.

Such encoding and decoding may, as shown in FIG. 4, comprise intra-coding or inter-prediction encoding of the frames of the first layer based on one or more reference frames selected from the first layer. The encoding and decoding may additionally comprise inter-prediction encoding of the second layer frames based on one or more reference frames selected from the first layer or the second layer. In some examples, the inter-prediction encoding of the second layer frames may use one or more upscaled frames of the first layer as reference frames in order to retain appropriate scale for the spatial and temporal predictions.

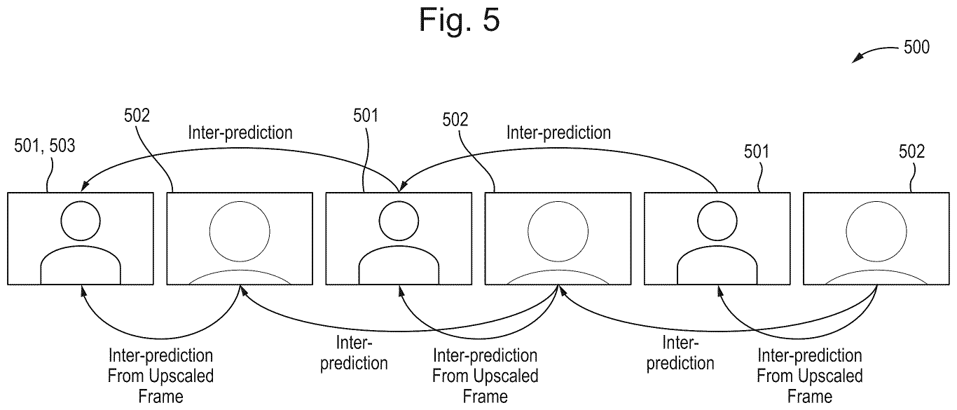

FIGS. 5-7 show respective illustrative examples 500, 600, 700 of an encoded video stream constructed and transmitted using the present systems and methods, such as described in relation to FIGS. 1A-4, for example during a video conference session. As an example, the encoding of the second layer frames of FIG. 4 may be initiated following receipt of a region of interest trigger, for example the detection of audio at a user device at a volume above a volume threshold, such as when the user is speaking during the video conference.

In FIG. 5, the encoded stream 500 may be constructed of frames from a first layer 501 and frames from a second layer 502 as described in relation to FIG. 4, in an interleaved manner, which may for example be performed while the corresponding user is speaking during the video conference session. Such an approach may provide optimal proximity of second layer frames 502 to corresponding first layer frames 501, for improved predictive power. As described in relation to FIG. 4, the encoding (and subsequent decoding) may comprise intra-coding or inter-prediction encoding of the frames of the first layer 501 based on one or more reference frames selected from the first layer only. The intra-coding and inter-frame encoding may be performed in any suitable manner, such as described in relation to FIGS. 1A-1C. In particular, the first frame 503 of the first layer 501 may be an independently decodable frame. The encoding (and subsequent decoding) may additionally comprise inter-prediction encoding of the second layer frames 502 based on one or more reference frames selected from the first layer 501 or the second layer 502. In some examples, the inter-prediction encoding of the second layer frames 502 may use one or more upscaled frames of the first layer 501 as reference frames in order to retain appropriate scale for the spatial and temporal predictions.

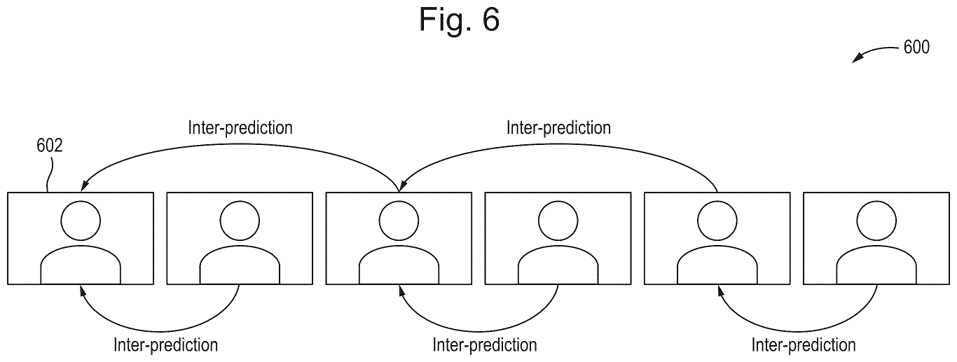

FIG. 6 shows an alternate example of an encoded video stream 600 to that shown in FIG. 5, for example when the user is not speaking during the video conference session. In the alternate example 600, the stream comprises only encoded frames from a first layer 601 since no region of interest trigger is received to initiate an encoding of the second layer frames. The encoding (and subsequent decoding) therefore comprises intra-coding or inter-prediction encoding of the frames of the first layer 601 based on one or more reference frames selected from the first layer only. The first frame 602 of the stream is an independently decodable frame.

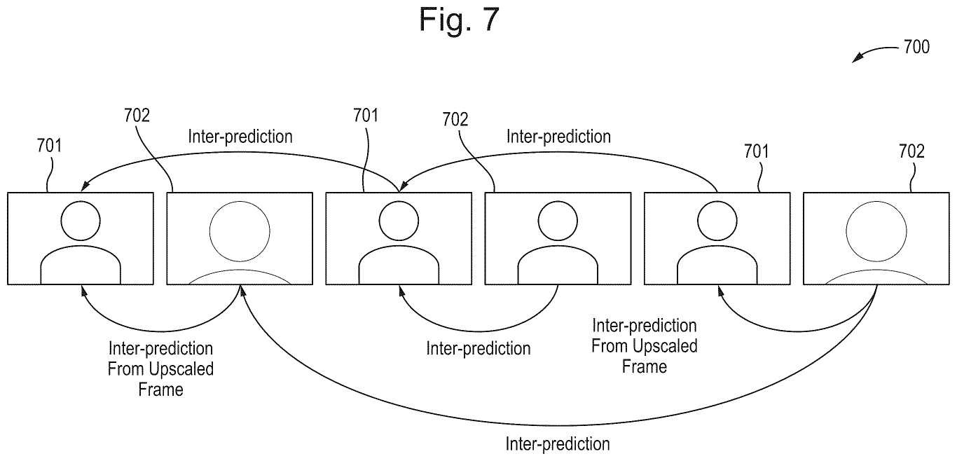

FIG. 7 shows a further alternate example of an encoded video stream 700 to that shown in FIG. 5 and FIG. 6, for example depicting an interval between speaking instances of the user during the video conference session. In FIG. 7, the stream 700 is constructed using encoded frames from the first layer 701 and the second layer 702 as previously described. While the example stream 500 of FIG. 5 represents a continued speaking duration of the user, in the alternate example 700 of FIG. 7 a combination of short-term and longer term predictive encoding may be used to provide inter-prediction encoding of frames of the second layer 702 spanning longer durations of no speech detected at the user device. The longer-term inter-prediction between the second layer frames 702 may provide improved predictive power over the sole use of the shorter-term inter-prediction based on a corresponding upscaled first layer frame 701.

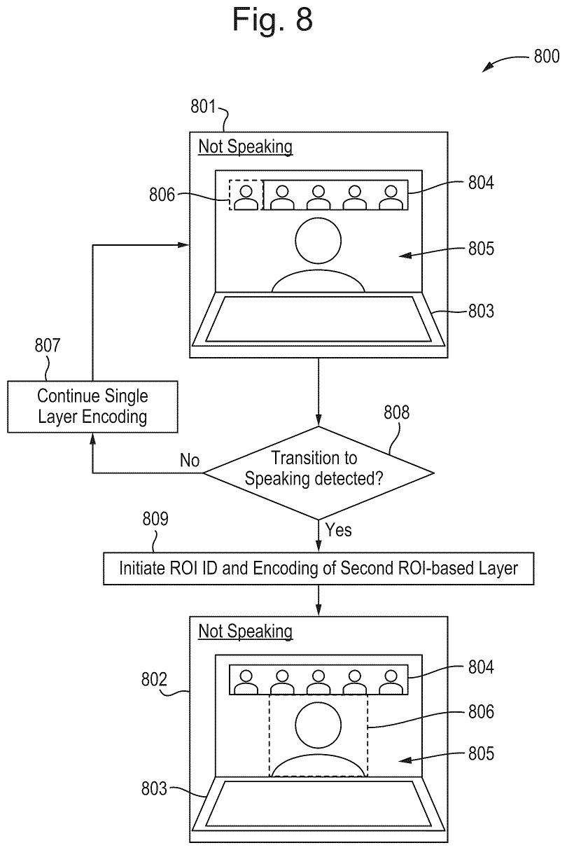

FIG. 8 shows an illustrative depiction of an example region of interest trigger process 800 suitable for use in a video conference session scenario (e.g., in line with that described in relation to FIGS. 1A-7). In particular, the scenario 800 depicts two stages 801, 802 of the video conference session when viewed from a video conference participant device 803, which in FIG. 8 is a computing device 803 (e.g., a laptop). The participant device 803 is configured to decode, for display, received encoded video streams from other participant devices.

During the video conference session, encoded video streams are communicated among participant devices 803 for decoding and displaying, each encoded video stream depicting a corresponding participant device user. At each participant device 803, a user interface is provided depicting a row of minimized decoded video streams 804 corresponding to each participant device user, and a larger central view 805 of a participant device user who is currently speaking.

Each of the encoded video streams may comprise a first encoded layer of non-enhanced video frames, comprising encoded raw image data captured at the respective participant device, the encoding performed at a particular resolution; a second encoded layer of region of interest video frames, comprising encoded region of interest data comprising a region selected from the raw image data, the width and height of the region equal that of the first encoded layer frames, the encoding performed at the particular resolution; or any combination thereof, as described herein. The presence of the second encoded layer of video frames within an encoded video stream may be responsive to a region of interest trigger, which in the video conference scenario described, may comprise the detection of audio (for example comprising speech) at a volume above a volume threshold indicating that a corresponding first user 806 is speaking. In some examples, the region of interest trigger may also, or instead, comprise the detection a network bandwidth availability above a bandwidth threshold.

Therefore, in the described scenario, at 807, when no speaking is detected at the first user device, the first user device continues to encode only the first encoded layer of frames for transmitting as a stream, the first encoded layer of frames received for decoding and displaying at other participating devices 803 in the minimized row 804 of the interface.

In the event that, at 808, a transition to speaking is detected for the first user 806, the first user device may, at 809, initiate encoding of the second layer frames for communicating as a video stream to the other participant devices 803, to be depicted at 802 in the larger central view 805 of the interface.

Both the first encoded layer and the second encoded layer are encoded and decoded at the same resolution and therefore require only a single encoder and decoder setting, thereby avoiding encoder and decoder level switching. In some examples, a composited video may be generated using the decoded first layer frames and the decoded second layer frames, substantially as described herein.

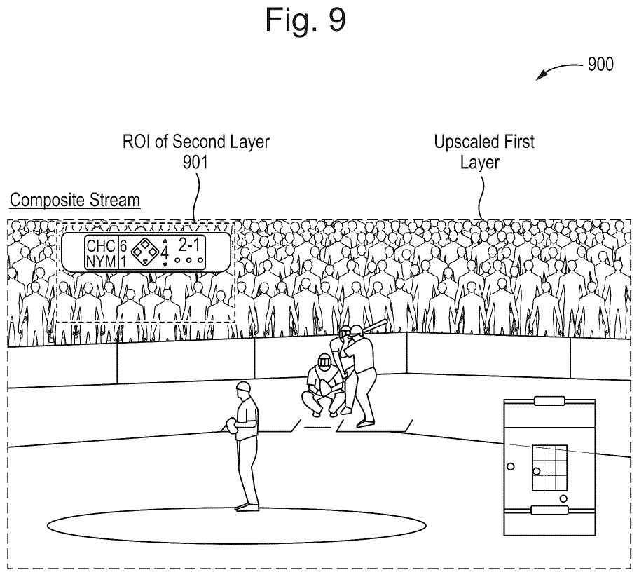

FIG. 9 shows a further illustrative depiction of an example application of the present systems and methods, in which a user is live streaming a baseball game 900 between the New York Mets™ and the Chicago Cubs™. The live stream 900 may be provided by way of any suitable broadcast server or content server (e.g., server 1104) to a user device (e.g., user equipment 1106, 1107, 1108, 1110). The live stream 900 may be accessed and encoded by the server for communicating as an encoded video stream to the user device. In some examples, instructions may be received from the user device to isolate, clip or crop a region of interest from the raw live stream, to be visually enhanced in the communicated stream. In some examples, the instructions may be received following a detection of a network bandwidth change at the user device, for example a network bandwidth below a bandwidth threshold. In some examples, the user device may present one or more options to the user for selecting a region of interest of the stream. The one or more options may be presented by way of a menu of predetermined options, which may be determined for example based on an image processing, computer vision or machine learning process, or as a result of an object detection or saliency analysis. The determination may be performed, in some examples, based on user input, which may for example comprise a selection performed by the user. In some examples, the region of interest may be automatically determined based at least in part on one or more parameters, for example based on a detected gaze direction of the user. In some examples, the region of interest may be automatically determined based on one or more visual characteristics of a frame region, for example an amount of movement within the region.

In a live stream of a sports game as depicted, an area of a frame occupied by a score board 901 may be determined or selected as a region of interest within the frame. As described in relation to FIGS. 1A-8, raw live stream data may be encoded as a first layer of the encoded video stream, frames of the encoded first layer having a particular number of pixels and encoded at a particular resolution. Region of interest data associated with the region of interest 901 (the scoreboard) may be encoded as a second layer of the encoded video stream, optionally responsive to the region of interest trigger. The region of interest comprises the particular number of pixels (arranged in a rectangular area having a width and height) and the region of interest data is encoded at the particular resolution, and therefore encoding of the first and second layers requires only a single encoder setting of an encoder. The encoded video stream, comprising the first and second layer, may be transmitted from the server to the user device for decoding as described herein, using only a single decoder setting of a decoder.

It will be appreciated that, some examples such as described herein, a compositing process may comprise any suitable image processing steps, such as edge smoothing. The compositing may, in some examples, comprise object detection and segmentation, which may provide a cleaner compositing of the region of interest with the corresponding first layer frame.

Examples will be appreciated wherein any suitable region of interest trigger is provided, such as described herein. In some examples, the region of interest trigger may be in accordance with an automatic region of interest detection, which may be performed in accordance with any suitable image processing, computer vision, object recognition or saliency analysis process. The region of interest trigger may, in some examples, be in accordance with an output of a training machine learning model which is provided at least in part with the raw video data, or of the first layer, and is configured to output an indication of the region of interest. The trained machine learning model may be trained at least in part on video frame data and corresponding predetermined regions of interest, the predetermined regions of interest determined by way of any suitable process, such as by human selection or by any suitable image processing, computer vision, object recognition or saliency analysis process. In some examples, the region of interest trigger may be in accordance with a user selected region of interest. Examples will be appreciated wherein the region of interest is one of a plurality of such regions of interest.

FIGS. 10-11 describe example devices, systems, servers, and related hardware for providing an enhanced stream of digital content, in accordance with some embodiments of this disclosure. FIG. 10 shows generalized embodiments of illustrative user equipment devices 1000 and 1001. For example, user equipment device 1000 may be a smartphone device. In another example, user equipment system 1001 may be a user television equipment system (e.g., user equipment 106 of FIG. 1). User television equipment system 1001 may include set-top box 1016. Set-top box 1016 may be communicatively connected to microphone 1018, speaker 1014, and display 1012. In some embodiments, microphone 1018 may receive voice commands for a media application. In some embodiments, display 1012 may be a television display or a computer display. In some embodiments, set-top box 1016 may be communicatively connected to user input interface 1010. In some embodiments, user input interface 1010 may be a remote control device. Set-top box 1016 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of user equipment devices are discussed below in connection with FIG. 10. Each one of user equipment device 1000 and user equipment system 1001 may receive content and data via input/output (“I/O”) path 1002. I/O path 1002 may provide content (e.g., broadcast programming, on-demand programming, Internet content, content available over a local area network (LAN) or wide area network (WAN), and/or other content) and data to control circuitry 1004, which includes processing circuitry 1006 and storage 1008. Control circuitry 1004 may be used to send and receive commands, requests, and other suitable data using I/O path 1002, which may comprise I/O circuitry. I/O path 1002 may connect control circuitry 1004 (and specifically processing circuitry 1006) to one or more communications paths (described below). I/O functions may be provided by one or more of these communications paths, but are shown as a single path in FIG. 10 to avoid overcomplicating the drawing.

Control circuitry 1004 may be based on any suitable processing circuitry such as processing circuitry 1006. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1004 executes instructions for a media application stored in memory (i.e., storage 1008). Specifically, control circuitry 1004 may be instructed by the media application to perform the functions discussed above and below. In some implementations, any action performed by control circuitry 1004 may be based on instructions received from the media application.

In client/server-based embodiments, control circuitry 1004 may include communications circuitry suitable for communicating with a media application server or other networks or servers. The instructions for carrying out the above mentioned functionality may be stored on a server (which is described in more detail in connection with FIG. 10. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of user equipment devices, or communication of user equipment devices in locations remote from each other (described in more detail below).

Memory may be an electronic storage device provided as storage 1008 that is part of control circuitry 1004. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1008 may be used to store various types of content described herein as well as media application data described above. Nonvolatile memory may also be used (e.g., to launch a boot-up routine and other instructions). Cloud-based storage, described in relation to FIG. 10, may be used to supplement storage 1008 or instead of storage 1008.

Control circuitry 1004 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1004 may also include scaler circuitry for upconverting and down converting content into the preferred output format of user equipment 1000. Circuitry 1004 may also include digital-to-analog converter circuitry and analog-to-digital converter circuitry for converting between digital and analog signals. The tuning and encoding circuitry may be used by user equipment device 1000, 1001 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1008 is provided as a separate device from user equipment device 1000, the tuning and encoding circuitry (including multiple tuners) may be associated with storage 1008.

A user may send instructions to control circuitry 1004 using user input interface 1010. User input interface 1010 may be any suitable user interface, such as a remote control, mouse, trackball, keypad, keyboard, touch screen, touchpad, stylus input, joystick, voice recognition interface, or other user input interfaces. Display 1012 may be provided as a stand-alone device or integrated with other elements of each one of user equipment device 1000 and user equipment system 1001. For example, display 1012 may be a touchscreen or touch-sensitive display. In such circumstances, user input interface 1010 may be integrated with or combined with display 1012. Display 1012 may be one or more of a monitor, a television, a display for a mobile device, or any other type of display. A video card or graphics card may generate the output to display 1012. The video card may be any processing circuitry described above in relation to control circuitry 1004. The video card may be integrated with the control circuitry 1004. Speakers 1014 may be provided as integrated with other elements of each one of user equipment device 1000 and user equipment system 1001 or may be stand-alone units. The audio component of videos and other content displayed on display 1012 may be played through the speakers 1014. In some embodiments, the audio may be distributed to a receiver (not shown), which processes and outputs the audio via speakers 1014.

The media application may be an encoder software application, or a decoder software application, such as described in relation to FIG. 1A-1C, or any suitable combination thereof.

The media application may be implemented using any suitable architecture. For example, it may be a stand-alone application wholly-implemented on each one of user equipment device 1000 and user equipment system 1001. In such an approach, instructions of the application are stored locally (e.g., in storage 1008), and data for use by the application is downloaded on a periodic basis (e.g., from an out-of-band feed, from an Internet resource, or using another suitable approach). Control circuitry 1004 may retrieve instructions of the application from storage 1008 and process the instructions to rearrange the segments as discussed. Based on the processed instructions, control circuitry 1004 may determine what action to perform when input is received from user input interface 1010. For example, movement of a cursor on a display up/down may be indicated by the processed instructions when user input interface 1010 indicates that an up/down button was selected.

In some embodiments, the media application is a client/server-based application. Data for use by a thick or thin client implemented on each one of user equipment device 1000 and user equipment system 1001 is retrieved on-demand by issuing requests to a server remote to each one of user equipment device 1000 and user equipment system 1001. In one example of a client/server-based guidance application, control circuitry 1004 runs a web browser that interprets web pages provided by a remote server. For example, the remote server may store the instructions for the application in a storage device. The remote server may process the stored instructions using circuitry (e.g., control circuitry 1004) to perform the operations discussed in connection with FIGS. 1-11.

In some embodiments, the media application may be downloaded and interpreted or otherwise run by an interpreter or virtual machine (run by control circuitry 1004). In some embodiments, the media application may be encoded in the ETV Binary Interchange Format (EBIF), received by the control circuitry 1004 as part of a suitable feed, and interpreted by a user agent running on control circuitry 1004. For example, the media application may be an EBIF application. In some embodiments, the media application may be defined by a series of JAVA-based files that are received and run by a local virtual machine or other suitable middleware executed by control circuitry 1004. In some of such embodiments (e.g., those employing MPEG-2 or other digital media encoding schemes), the media application may be, for example, encoded and transmitted in an MPEG-2 object carousel with the MPEG audio and video packets of a program.

FIG. 11 is a diagram of an illustrative streaming system, in accordance with some embodiments of the disclosure. User equipment devices 1107, 1107, 1110 (e.g., user equipment device 106) may be coupled to communication network 1106. Communication network 1106 may be one or more networks including the Internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 1106) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 11 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 1106.

System 1100 includes a media content source 1102 and a server 1104, which may comprise or be associated with database 1105. Communications with media content source 1102 and server 1104 may be exchanged over one or more communications paths but are shown as a single path in FIG. 11 to avoid overcomplicating the drawing. In addition, there may be more than one of each of media content source 1102 and server 1104, but only one of each is shown in FIG. 11 to avoid overcomplicating the drawing. If desired, media content source 1102 and server 1104 may be integrated as one source device.

In some embodiments, server 1104 may include control circuitry 1111 and a storage 1114 (e.g., RAM, ROM, Hard Disk, Removable Disk, etc.). Server 1104 may also include an input/output path 1112. I/O path 1112 may provide device information, or other data, over a local area network (LAN) or wide area network (WAN), and/or other content and data to the control circuitry 1111, which includes processing circuitry, and storage 1114. The control circuitry 1111 may be used to send and receive commands, requests, and other suitable data using I/O path 1112, which may comprise I/O circuitry. I/O path 1112 may connect control circuitry 1104 (and specifically processing circuitry) to one or more communications paths.

Control circuitry 1111 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1111 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 1111 executes instructions for an emulation system application stored in memory (e.g., the storage 1114). Memory may be an electronic storage device provided as storage 1114 that is part of control circuitry 1111.

Server 1104 may retrieve guidance data from media content source 1102, process the data as will be described in detail below, and forward the data to \user equipment devices 1107 and 1110. Media content source 1102 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 1102 may be the originator of content (e.g., a television broadcaster, a Webcast provider, etc.) or may not be the originator of content (e.g., an on-demand content provider, an Internet provider of content of broadcast programs for downloading, etc.). Media content source 1102 may include cable sources, satellite providers, on-demand providers, Internet providers, over-the-top content providers, or other providers of content. Media content source 1102 may also include a remote media server used to store different types of content (including video content selected by a user), in a location remote from any of the client devices. Media content source 1102 may also provide metadata that can be used to identify important segments of media content as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 1104), which may be located centrally or at distributed locations, that provide cloud-based services to various types of users and devices connected via a network such as the Internet via communication network 1106. In such embodiments, user equipment devices may operate in a peer-to-peer manner without communicating with a central server.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A method comprising:
accessing, by a first device, video data for encoding;
encoding the video data at a particular resolution to generate a first plurality of encoded frames, wherein each frame of the first plurality of encoded frames comprises a particular number of pixels;
identifying a region of interest of the video data, wherein the region of interest has the particular number of pixels;
encoding, based on the identified region of interest, region of interest data at the particular resolution to generate a second plurality of encoded frames, wherein each frame of the second plurality of encoded frames has the particular number of pixels; and
transmitting the first plurality of encoded frames and the second plurality of encoded frames to a second device for decoding, wherein the second device is configured to:
decode the first plurality of encoded frames and the second plurality of encoded frames; and
generate for output an output video based at least in part on the first plurality of decoded frames and the second plurality of decoded frames.

2. The method of claim 1, wherein the second device is further configured to:
upscale the first plurality of decoded frames;
composite each respective frame of the upscaled first plurality of decoded frames with a respective frame of the second plurality of decoded frames; and
wherein the generating for output the output video is based at least in part on the compositing.

3. The method of claim 2, wherein the encoding the second plurality of frames comprises encoding a first frame of the second plurality of frames to be decodable based at least in part on decoding and upscaling a second frame of the first plurality of frames.

4. The method of claim 1, wherein the identifying the region of interest is initiated based at least in part on determining that the video data has transitioned from depicting a participant in a video conference who is silent, to depicting the participant speaking.

5. The method of claim 1, wherein the identifying the region of interest comprises:
providing one or more video frames of the video data as an input to a machine learning model; and
receiving as an output, from the machine learning model, data indicating the region of interest comprising the particular number of pixels based on the video frames;
wherein the machine learning model is trained on a training dataset comprising historic video data and corresponding user-identified regions of interest of the video data.

6. The method of claim 1, wherein the particular number of pixels is arranged as a rectangular area of pixels having a fixed height and a fixed width.

7. The method of claim 1, wherein the region of interest comprises a fixed size rectangular area of pixels, wherein the respective position of the rectangular area is different in different respective frames of the video data.

8. The method of claim 1,
wherein the first plurality of encoded frames comprises at least one first intra coded frame and a first set of inter-coded frames,
wherein each frame of the first set of inter-coded frames is decodable based on decoding of one or more other frames of the first plurality of frames; and
wherein the second plurality of encoded frames comprises a second set of inter-coded frames;
wherein each frame of the second set of inter-coded frames is decodable based on decoding one or more other frames of the first plurality of frames and/or one or more other frames of the second plurality of frames.

9. The method of claim 1, wherein the second device is configured to decode the first plurality of encoded frames and the second plurality of encoded frames using a single decoder.

10. A method comprising:
receiving, by a first device, a first plurality of video frames of a video stream encoded at a particular resolution, wherein each frame of the first plurality of video frames comprises a particular number of pixels;
receiving, by the first device, a second plurality of video frames encoded at the particular resolution, wherein the second plurality of video frames is based on data corresponding to a region of interest of the first plurality of video frames, wherein each frame of the second plurality of video frames comprises the particular number of pixels;
decoding, using a decoder operating with particular settings, the first plurality of encoded video frames;
upscaling the first plurality of decoded frames;
decoding, using the decoder operating with the particular settings, the second plurality of encoded video frames; and
generating, for display, a composited video generated at least in part based on compositing each respective frame of the upscaled first plurality of decoded frames with a respective frame of the second plurality of decoded frames.

11. A system comprising:
a first device comprising:
input/output circuitry configured to access video data for encoding; and
control circuitry configured to:
encode the video data at a particular resolution to generate a first plurality of encoded frames, wherein each frame of the first plurality of encoded frames comprises a particular number of pixels;
identify a region of interest of the video data, wherein the region of interest has the particular number of pixels; and
encode, based on the identified region of interest, region of interest data at the particular resolution to generate a second plurality of encoded frames, wherein each frame of the second plurality of encoded frames has the particular number of pixels;
wherein the input/output circuitry is further configured to transmit the first plurality of encoded frames and the second plurality of encoded frames to a second device for decoding, wherein the second device comprises control circuitry configured to:
decode the first plurality of encoded frames and the second plurality of encoded frames; and
generate for output an output video based at least in part on the first plurality of decoded frames and the second plurality of decoded frames.

12. The system of claim 11, wherein the control circuitry of the second device is further configured to:
upscale the first plurality of decoded frames;
composite each respective frame of the upscaled first plurality of decoded frames with a respective frame of the second plurality of decoded frames; and
wherein the generating for output the output video is based at least in part on the compositing.

13. The system of claim 12, wherein the encoding the second plurality of frames comprises, by the control circuitry of the first device, encoding a first frame of the second plurality of frames to be decodable based at least in part on decoding and upscaling a second frame of the first plurality of frames.

14. The system of claim 11, wherein the identifying the region of interest is initiated, by the control circuitry of the first device, based at least in part on determining that the video data has transitioned from depicting a participant in a video conference who is silent, to depicting the participant speaking.

15. The system of claim 11, wherein the identifying the region of interest comprises, by the control circuitry of the first device:
providing one or more video frames of the video data as an input to a machine learning model; and
receiving as an output, from the machine learning model, data indicating the region of interest comprising the particular number of pixels based on the video frames;
wherein the machine learning model is trained on a training dataset comprising historic video data and corresponding user-identified regions of interest of the video data.

16. The system of claim 11, wherein the particular number of pixels is arranged as a rectangular area of pixels having a fixed height and a fixed width.

17. The system of claim 11, wherein the region of interest comprises a fixed size rectangular area of pixels, wherein the respective position of the rectangular area is different in different respective frames of the video data.

18. The system of claim 11,
wherein the first plurality of encoded frames comprises at least one first intra coded frame and a first set of inter-coded frames,
wherein each frame of the first set of inter-coded frames is decodable by the control circuitry of the second device based on decoding of one or more other frames of the first plurality of frames; and
wherein the second plurality of encoded frames comprises a second set of inter-coded frames;
wherein each frame of the second set of inter-coded frames is decodable by the control circuitry of the second device based on decoding one or more other frames of the first plurality of frames and/or one or more other frames of the second plurality of frames.

19. The system of claim 11, wherein the control circuitry of the second device is configured to decode the first plurality of encoded frames and the second plurality of encoded frames using a single decoder.

20-50. (canceled)
